(19) United States
(12) Patent Application Publication
(10) Pub. No.: US 2010/0059328 A1
(43) Pub. Date: Mar. 11, 2010

(54) Detachable Rear Cover for Bill-Receiving Apparatus

(76) Inventor: John Pai, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/206,787

(22) Filed: Sep. 9, 2008

(51) Int. Cl. G07F 7/04

(52) U.S. Cl. 194/206

(57) ABSTRACT

A bill-receiving apparatus includes a shell, a front cover, a sensor assembly, a bill-feeding mechanism and a detachable rear cover unit. The shell includes two lateral walls each including a cutout defined in a rear edge. The cutout includes a narrowed mouth. The front cover is attached to a front side of the shell. The front cover includes a slot through a bill can be inserted. The sensor assembly is arranged behind the front cover and used to detect the bill. The bill-feeding mechanism feeds the bill under the control of the sensor assembly. The detachable rear cover unit includes two flank walls and two detents elastically attached to the flank walls. Each detent includes a rod for trapping in a related one of the cutouts and a tip for moving from a related one of the cutouts through the mouth.

### BACKGROUND OF INVENTION

The present invention relates to a detachable rear cover and, more particularly, to a detachable rear cover for a bill-receiving apparatus.

Automatic teller machines are common in modern societies. Each automatic teller machine is equipped with a bill-receiving apparatus for receiving bills. A first conventional bill-receiving apparatus includes a shell, a front cover, two lateral covers, a rear cover, a bill-feeding mechanism, an upper sensor and a lower sensor. The front and rear covers are secured to the shell. The front cover includes a slot through which a bill can be inserted. The upper sensor is arranged between the slot and the bill-feeding mechanism. The bill-feeding mechanism includes a motor and two pulley-belt modules. Each of the pulley-belt modules includes a roller, a driving pulley, two guiding pulleys and a tensioning pulley rotationally mounted on a related one of the lateral covers and an end-less belt wound around the pulleys. The driving pulley of each of the pulley-belt modules is operatively connected to the motor. After a bill is inserted into the bill-receiving apparatus through the slot of the front cover, the upper sensor detects the coming of the bill and actuates the bill-feeding mechanism to feed the bill. If there is a problem with the upper sensor or a jam in an upstream section of the bill-feeding mechanism, the upper sensor can be detached so that the upper sensor can be repaired or the jam can be removed. However, if there is a jam in a downstream section of the bill-feeding mechanism, it will be difficult to remove the jam after the upper sensor is detached.

A second conventional bill-receiving apparatus includes a shell, a front cover, two lateral covers, a bill-feeding mechanism, a box, an upper sensor and a lower sensor. The front cover is secured to a front side of the shell. The lateral covers are detachably attached to lateral sides of the shell. The box is detachably attached to a rear side of the shell. The front cover includes a slot through which a bill can be inserted into the bill-receiving apparatus. The upper sensor is arranged between the slot and the bill-feeding mechanism. The bill-feeding mechanism includes a motor and two pulley-belt modules. Each of the pulley-belt modules includes a roller, a driving pulley, two guiding pulleys and a tensioning pulley rotationally mounted on a related one of the lateral covers and an end-less belt wound around the pulleys. The driving pulley of each of the pulley-belt modules is operatively connected to the motor. The box is arranged behind the bill-feeding mechanism. After a bill is inserted into the bill-receiving apparatus through the slot of the front cover, the upper sensor detects the coming of the bill and actuates the bill-feeding mechanism to feed the bill into the box. If there is a problem with the upper sensor or a jam in an upstream section of the bill-feeding mechanism, the upper sensor can be detached so that the upper sensor can be repaired or the jam can be removed. If there is a jam in a downstream section of the bill-feeding mechanism, the box can be detached to facilitate the removal of the jam.

Therefore, the present invention is intended to obviate or at least alleviate the problems encountered in prior art.

### SUMMARY OF INVENTION

It is the primary objective of the present invention to provide a bill-receiving apparatus equipped with a detachable rear cover to facilitate trouble-shooting.

To achieve the foregoing objective, the bill-receiving apparatus includes a shell, a front cover, a sensor assembly, a bill-feeding mechanism and a detachable rear cover unit. The shell includes two lateral walls each including a cutout defined in a rear edge. The cutout includes a narrowed mouth. The front cover is attached to a front side of the shell. The front cover includes a slot through a bill can be inserted. The sensor assembly is arranged behind the front cover and used to detect the bill. The bill-feeding mechanism feeds the bill under the control of the sensor assembly. The detachable rear cover unit includes two flank walls and two detents elastically attached to the flank walls. Each detent includes a rod for trapping in a related one of the cutouts and a tip for moving from a related one of the cutouts through the mouth.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a side view of a bill-receiving apparatus according to the preferred embodiment of the present invention.

FIG. 2 is an exploded view of the bill-receiving apparatus shown in FIG. 1.

FIG. 3 is an exploded view of a detachable rear cover unit of the bill-receiving apparatus shown in FIG. 1.

FIG. 4 is a cross-sectional view of the bill-receiving apparatus shown in FIG. 1.

### DETAILED DESCRIPTION OF PREFERRED EMBODIMENT

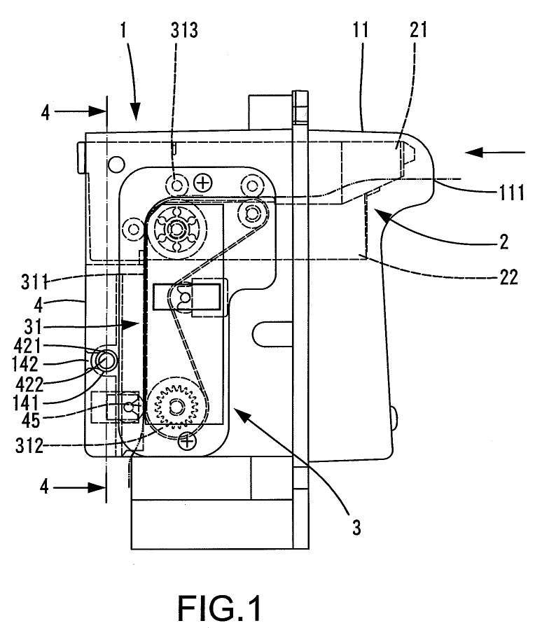

Referring to FIG. 1, a bill-receiving apparatus includes a shell 1, a front cover 11, two lateral covers 12, a detachable rear cover unit 4, a bill-feeding mechanism 3 and a sensor assembly 2 according to the preferred embodiment of the present invention. The shell 1 includes two lateral walls 14 each including an opening 13 defined therein and a cutout 141 defined in a rear edge. The cutout 141 includes a mouth 142 so that the width of the mouth 142 is smaller than the remaining portion of the cutout 141.

The front cover 11 is securely attached to a front side of the shell 1, thus covering a front opening. The front cover 11 includes a slot 111 through which a bill can be inserted into the bill-receiving apparatus.

The sensor assembly 2 includes an upper sensor 21 and a lower sensor 22. The bill can be fed along a path defined between the upper sensor 21 and the lower sensor 22. The upper sensor 21 includes a rear portion for covering an upper portion of a rear opening of the shell 1.

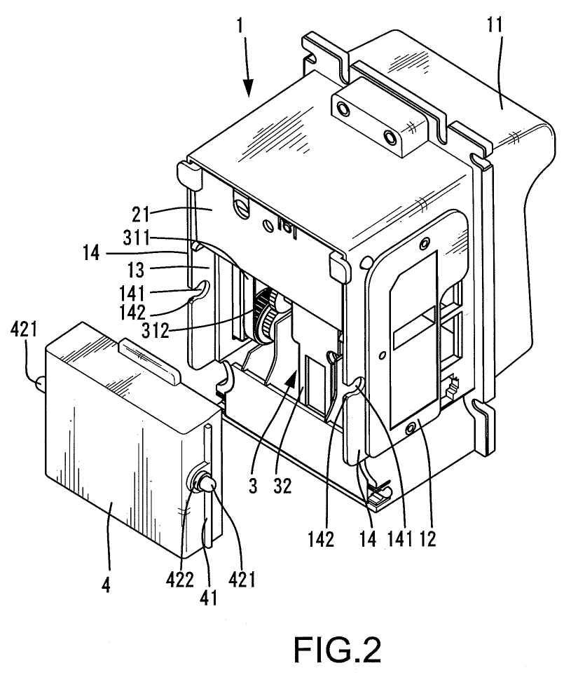

Referring to FIG. 2, the bill-feeding mechanism 3 includes a motor 32 and two pulley-belt modules 31. Each of the pulley-belt modules 31 includes a driving pulley 312, two guiding pulleys, an endless belt 311 and a roller 313. The driving pulley 312, the guiding pulleys and the roller 313 of each of the pulley-belt modules 31 are rotationally mounted on a related one of the lateral covers 12. The end-less belt 311 is wound around the driving pulley 312 and the guiding pulleys. The driving pulley 312 is operatively connected to the motor 32. The roller 313 can push the bill against the endless belt 311. The lateral covers 12 are attached to the lateral walls 14, thus covering the openings 13.

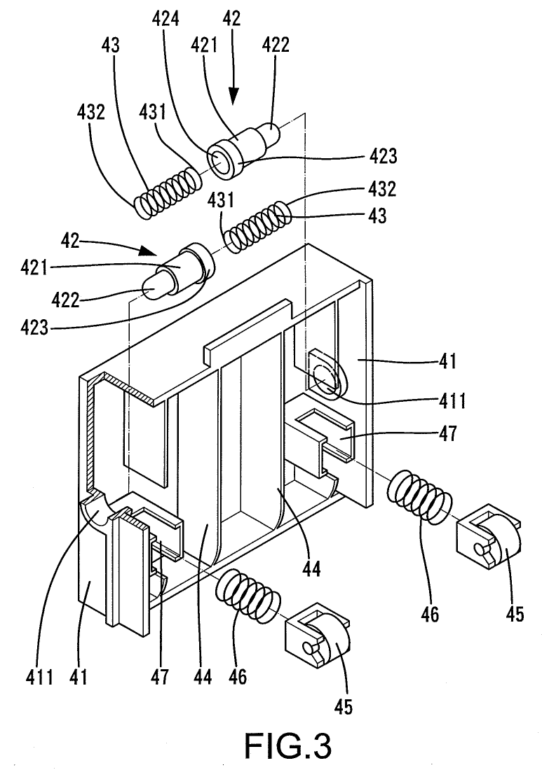

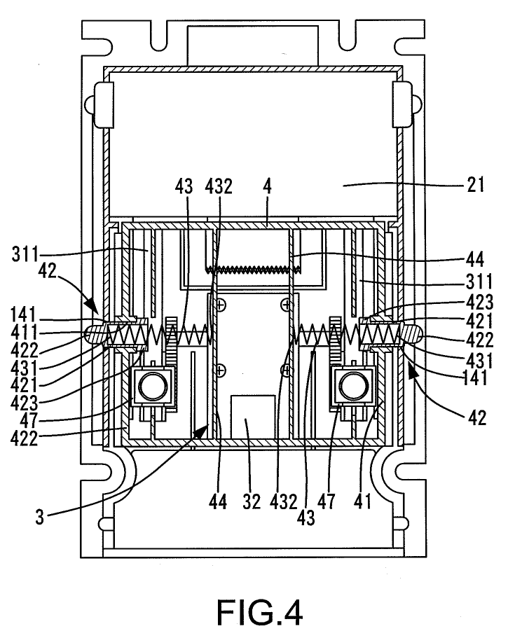

Referring to FIGS. 3 and 4, the detachable cover unit 4 includes two flank walls 41, two plates 44, two detents 42, two springs 43, two seats 47, two rollers 45, and two springs 46. Each of the flank walls 41 includes an aperture 411 defined therein. The plates 44 are formed between the flank walls 41. Each of the seats 47 is located between a related one of the flank walls 41 and a related one of the plates 44.

Each detent 42 includes a rod 421, a tip 422 formed at an end of the rod 421 and a flange 423 formed at an opposite end of the rod 421. The diameter of the tip 422 is smaller than that of the rod 421. The diameter of the rod 421 is smaller than that of the flange 423. The diameter of the rod 421 is smaller than the width of the cutouts 141 but larger than the width of the mouths 142. The diameter of the tip 422 is marginally smaller than the width of the mouths 142. Each detent 42 is inserted through a related one of the apertures 411 so that the tip 422 and a portion of the rod 421 are located beyond a related one of the flank walls 41. The flanges 423 of the detents 42 abut the flank walls 41.

Each of the springs 43 includes an end 431 abutted against a related one of the plates 44 and an opposite end 423 inserted in the space 424 of a related one of the detents 42. Thus, each of the springs 43 is compressed between a related one of the plates 44 and a related one of the detents 42 to keep the tip 422 and the portion of the rod 421 beyond a related one of the flank walls 41.

Each of the springs 46 and a related one of the rollers 45 are disposed in a related one of the seats 47 so that each of the springs 46 is used to push a related one of the rollers 45 against a related one of the endless belts 311. The rollers 45 are used as tensioning rollers.

To attach the detachable rear cover unit 4 to the lateral walls 14, a user pushes the detents 42 by the tips 421 to move at least the rods 422 completely into the apertures 411. Then, the user moves the tips 421 of the detents 42 into the cutouts 141 through the mouths 142. Finally, the user releases the detents 42 to let the springs 43 push the rods 422 partially into the cutouts 141. Thus, the detachable rear cover unit 4 is attached to the lateral walls 14. The detachable rear cover unit 4 covers a lower portion of the rear opening of the shell 1.

To detach the detachable rear cover unit 4 from the lateral walls 14, a user pushes the detents 42 by the tips 421 to move at least the rods 422 completely into the apertures 411. Then, the user moves the tips 421 of the detents 42 from the cutouts 141 through the mouths 142, and detaches the detachable rear cover unit 4 from the lateral walls 14.

In use, after the bill is inserted into the bill-receiving apparatus through the slot 111 of the front cover 11, the upper sensor 21 detects the coming of the bill and actuates the bill-feeding mechanism 3 to feed the bill to a box (not shown) located below the bill-feeding mechanism 3. If there is a problem with the upper sensor 21 or a jam in an upstream section of the bill-feeding mechanism 3, the upper sensor 21 can be detached so that the upper sensor 21 can be repaired or the jam can be removed. If there is a jam in a downstream section of the bill-feeding mechanism 3, the detachable rear cover unit 4 can be detached from the lateral walls 14 to facilitate the removal of the jam.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A bill-receiving apparatus comprising:
a shell comprising two lateral walls each comprising a cutout defined in a rear edge and made with a narrowed mouth;
a front cover attached to a front side of the shell, wherein the front cover comprises a slot through a bill can be inserted;
a sensor assembly arranged behind the front cover and used to detect the coming of the bill;
a bill-feeding mechanism for feeding the bill under the control of the sensor assembly; and
a detachable rear cover unit comprising:
two flank walls; and
two detents each elastically attached to a related one of the flank walls and formed with a rod for trapping in a related one of the cutouts and a tip for moving from a related one of the cutouts through the mouth.

2. The bill-receiving apparatus according to claim 1, wherein the rods of the detents are wider than the mouths of the cutouts and can be trapped in the cutouts, and each of the detents comprises a space, and the detachable rear cover unit comprises two plates formed between the flank walls and two springs each formed with an end abutted against a related one of the flank walls and an opposite end inserted in the space of a related one of the detents.

3. The bill-receiving apparatus according to claim 1, wherein the tips of the detents are marginally narrower than the mouths of the cutouts, and each of the detents is formed with a flange for abutment against a related one of the flank walls so that the tip and a portion of the rod are beyond the related flank wall.

4. The bill-receiving apparatus according to claim 1, wherein the bill-feeding mechanism comprises two endless belts, and the detachable rear cover unit comprises two seats, two rollers movably disposed in the seats and two springs disposed in the seats and used to push the springs against the endless belts.

5. The bill-receiving apparatus according to claim 1, wherein the sensor assembly comprises an upper sensor and a lower sensor so that the bill can be fed through a path defined between them.

6. The bill-receiving apparatus according to claim 5, wherein the upper sensor and the detachable rear cover together cover a rear opening of the shell.
